(19) United States
(12) Patent Application Publication
(10) Pub. No.: US 2010/0186703 A1
(43) Pub. Date: Jul. 29, 2010

(54) STARTER FOR INTERNAL COMBUSTION ENGINES HAVING A LOAD ALLEVIATION SWITCH

(76) Inventors: Jochen Heusel, Reutlingen (DE); Martin Neuburger, Geislingen (DE); Jie Ge, Stuttgart-Hausen (DE); Klaus Heyers, Reutlingen (DE); Apostolos Tsakiris, Ludwigsburg (DE)

Correspondence Address: KENYON & KENYON LLP, ONE BROADWAY, NEW YORK, NY, 10004, US

(21) Appl. No.: 12/444,524

(22) PCT Filed: Aug. 8, 2007
(86) PCT No.: PCT/EP07/58275

§ 371 Date: Apr. 12, 2010

(30) Foreign Application Priority Data
Oct. 9, 2006 (DE) 102006047608.5

(51) Int. Cl. F02N 11/08

(52) U.S. Cl. 123/179.3

(57) ABSTRACT

The invention relates to a starter for starting of an internal combustion engine, comprising a starter relay (1) having a relay switch (2). A main current path (7) to a starter motor (4) can be opened or closed with said relay switch. The service life of the starter relay (1) can be increased considerably if a further switch (9) is provided in addition to the relay switch (1), the further switch being actuated by means of an electronic system (10) such that it is closed at least at the time at which the relay switch (2) opens and/or closes.

### BACKGROUND INFORMATION

Internal combustion engines of today's motor vehicles are generally started by a so-called pinion starter. Pinion starters include a DC motor having a pinion which is engaged with a toothed ring on the internal combustion engine, and cranks the internal combustion engine when there is a starting request. The toothed ring of the internal combustion engine is usually located on the crankshaft. In addition, some known pinion starters include a so-called starter solenoid switch which activates an engaging lever which meshes the pinion with the toothed ring of the internal combustion engine. As soon as the engagement relay is activated, a main current path is automatically closed, which supplies the starter with electric power. This starts the actual cranking process.

During the switching on and off of the main current path, the contacts of the relay switch are greatly stressed. The reason for this is the high field strengths occurring during the switching of the inductive load (electric motor), which are able to lead to an electric sparkover, if the field strength is greater than the breakdown field strength. This effect is also designated as “relay fire” or “contact welding”. In vehicles designed for start-stop operation, the starter relay is operated more often, by a multiple, than in usual vehicles. The effect described above is therefore particularly critical, and is able to impair the service life of the starter substantially.

### SUMMARY OF THE INVENTION

It is therefore an object of the present invention to provide a starter for internal combustion engines, especially a pinion starter, which has a substantially higher service life.

An important aspect of the present invention is providing an additional switch, parallel to the relay switch of the starter relay (starter solenoid switch), and controlling this switch in such a way that it is closed at least at the time at which the relay switch opens and/or closes. In this context, the switch in effect forms a bypass, and is used to unload the relay switch. The closing of the bypass switch has the effect that the voltage present at the relay switch drops off, and thus the danger of a relay fire is reduced. Consequently, the service life of the starter is able to be extended considerably.

The field strengths occurring at the contacts of the relay switch are particularly high when the relay switch opens. It is provided, therefore, to keep the bypass switch closed at least at the time when the relay switch opens. The bypass switch is preferably closed at each change of state of the relay switch.

According to a first specific embodiment of the present invention, the bypass switch is closed shortly before a change of state of the relay switch, and is opened again shortly thereafter. The voltage dropping off at the relay switch is thereby reduced at the time of a switching procedure.

According to a second specific embodiment of the present invention, a bypass switch is also closed during the entire duration during which the relay switch is closed. In this case, the current flows to the starter motor so as to supply the starter motor both via the main current path and the relay switch and via the parallel connection path and the bypass switch.

The bypass switch is preferably connected to a supply potential, such as the battery voltage of the vehicle electrical system, and to the starter motor.

The bypass switch is preferably a transistor, especially an MOS transistor.

The starter according to the present invention is preferably a so-called pinion starter. The present invention may, of course, also be used for other types of starters having a starter relay.

### BRIEF DESCRIPTION OF THE DRAWINGS

FIG. 1 shows a starter for passenger vehicle internal combustion engines having a bypass switch.

FIG. 2a shows the switching state of the relay switch.

FIG. 2b shows the switching state of the bypass switch.

### DETAILED DESCRIPTION

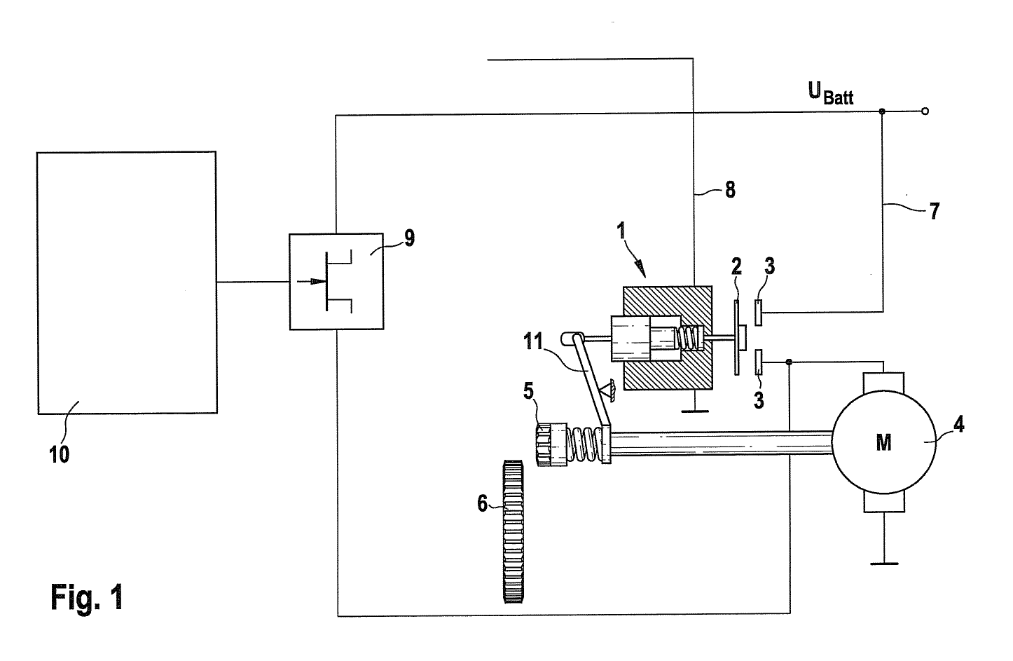

FIG. 1 shows a schematic representation of a pinion starter for starting an internal combustion engine. The pinion starter includes a starter relay 1, by which a main current path 7 to starter motor 4 is able to be opened and closed. When there is a start command (e.g. by the operation of the ignition), control line 8 of starter relay 1 is supplied with current, so that relay 1 is activated. An engaging lever 11 is thereby operated, which meshes pinion 5 with a toothed ring 6 of the passenger vehicle internal combustion engine (not shown). As soon as pinion 5 has been meshed with toothed ring 6, relay switch 2 closes automatically, and starter motor 4 is supplied with electric power. This starts the actual cranking process of the passenger vehicle internal combustion engine. Once the internal combustion engine runs by itself, pinion 5 backs out of toothed ring 6, and relay switch 2 opens again.

During opening and closing of relay switch 2, high field strengths may occur at switch contacts 3 of relay switch 2, which are able to lead to an electrical sparkover (so-called contact welding). This markedly impairs the service life of relay 1.

In order to prevent this, an additional switch 9 is provided in this instance, which is situated in parallel to relay switch 2, and which is operated so that it is closed at least during the switching on and/or off of relay switch 2. Additional switch 9 in effect forms a bypass of relay switch 2 and is used to unload relay switch 2 during a switching procedure. On the supply side, bypass switch 9 is connected to network voltage U_{bat}, and on the ground side it is connected to a supply side node of starter motor 4. An electronics system 10, such as a control unit, is provided for controlling bypass switch 9.

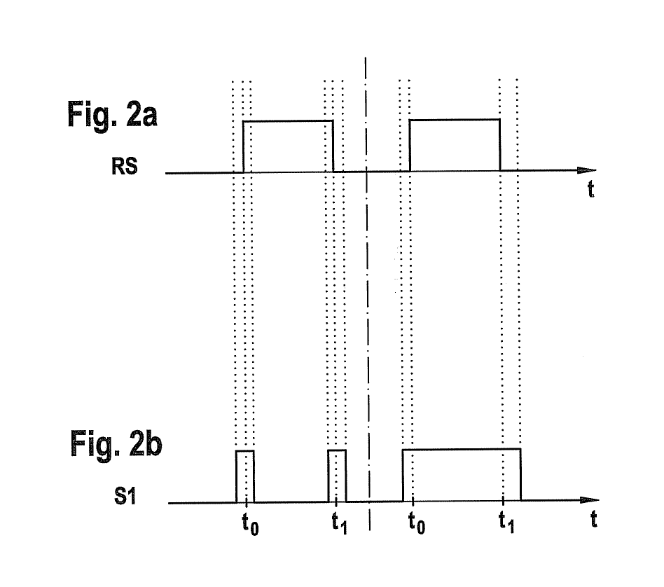

FIG. 2a shows two switching cycles of relay switch 2, the state “low” corresponding to the opened setting and the state “high” corresponding to the closed setting of relay switch 2.

FIG. 2b shows the switching state of switch 9, to the left of the dotted line a first operating type being shown, and to the right of the dotted line a second operating type being shown. The state “low” again corresponds to the opened setting and the state “high” corresponds to the closed setting.

In the first operating type, switch 9 is controlled in such a way that, in each case, shortly before a change in state of relay switch 2, it is closed and shortly after that it is opened again (see times t₀ and t₁). The voltage dropping off at relay switch 2 is thereby reduced, and consequently the danger of contact welding is diminished.

In second operating type B, parallel switch 9 is operated in such a way that it is also switched on during the entire switch-on phase of relay switch 2 (from t₀ to t₁). Switch 9 is switched on shortly before time t₀ and switched off again shortly after time t₁. The important point is that switch 9 is closed during a change in state of relay switch 2.

Switch 9 may be a transistor, for instance, especially an MOS transistor.

1-7. (canceled)

8. A starter for starting an internal combustion engine, comprising:
a starter relay having a relay switch, using which a main current path to a starter motor is opened and closed;
an additional switch in parallel to the relay switch; and
an electronics system for controlling the additional switch in such a way that it is closed at least at a time at which the relay switch opens and/or closes.

9. The starter according to claim 8, wherein the additional switch is closed at least at the time at which the relay switch opens.

10. The starter according to claim 8, wherein the additional switch is closed shortly before a change in state of the relay switch and is opened again shortly thereafter.

11. The starter according to claim 8, wherein the additional switch is closed during a time duration in which the relay switch is closed.

12. The starter according to claim 8, wherein the additional switch is connected to a supply potential and to a node on a supply side of the starter motor.

13. The starter according to claim 8, wherein the additional switch is implemented as a transistor.

14. The starter according to claim 8, wherein the starter is a pinion starter.
